(19) United States
(12) Patent Application Publication
(10) Pub. No.: US 2003/0178955 A1
(43) Pub. Date: Sep. 25, 2003

(54) Alternating current dynamotor for vehicle

(75) Inventor: Shin Kusase, Oobu-shi (JP)

Correspondence Address: OLIFF & BERRIDGE, PLC, P.O. BOX 19928, ALEXANDRIA, VA, 22320, US

(73) Assignee: DENSO CORPORATION, Kariya-City (JP)

(21) Appl. No.: 10/384,580

(22) Filed: Mar. 11, 2003

(30) Foreign Application Priority Data
Mar. 20, 2002 (JP) 2002-077473

(51) Int. Cl. H02P 5/00

(52) U.S. Cl. 318/139

(57) ABSTRACT

An object of the present invention is to improve, without greatly raising a production cost, both a starting-up characteristics during motor operation and power generation characteristics during dynamo operation. The AC dynamotor of the present invention comprises: a rotor with field magnet poles; an armature with three-phase windings provided in slots of the armature iron core; and AC/DC power converter. The induced electromotive voltages during the dynamo operation in the three-phase windings are rectified and outputted by the AC/DC power converter. The DC voltage applied from outside to the AC/DC power converter is converted into AC voltage and applied to the three-phase windings. A two-phase excitation at a lower rotation range including a starting-up timing during the motor operation is executed by a control of a vector control gate controller. On the other hand, a three-phase excitation is executed during the dynamo operation.

### BACKGROUND OF THE INVENTION

1. Field of the Invention

The present invention relates to an alternating current dynamotor which is mounted on a vehicle in order to generate an alternating current and to function as a motor.

2. Description of the Related Art

Recently, dynamos for vehicles function are also used as motors for starting engines and for auxiliary engines for running at a high speed rotation range. Particularly when the engines or vehicles are started by the AC dynamotor, large starting torque is required. At the same time, high electric power must be generated during a dynamo operation. However, it is difficult to satisfy those contradictory requirements. Concretely, although it is effective to increase a gross electric current by increasing a number of turns of an armature winding in order to obtain the large starting torque, the winding reactance of the armature winding become increased due to the increased number of turns of the winding, thereby decreasing the generated power during the high speed rotation. On the other hand, a decrease in the number of turns for the purpose of improving the power generation during the high speed rotation causes poor starting torque.

There are several methods for satisfying those contradictory requirements. For example, the number of turns of the armature winding may be switched, depending upon the dynamo operation or motor operation. Further, a large capacity switching device may be employed to start the AC dynamotor at the motor operation. However, above-mentioned solutions are costly and not the best. Therefore, there has been desired a method for improving the starting characteristics during the motor operation and electric power generation characteristics without any sharp raise in a production cost.

### SUMMARY OF THE INVENTION

An object of the present invention is to improve, without greatly raising a production cost, both a starting-up characteristics during motor operation and power generation characteristics during dynamo operation.

The AC dynamotor of the present invention comprises: a rotor with field magnet poles; an armature with three-phase windings provided in slots of the armature iron core; and an AC/DC electric power converter. The induced electromotive voltages during the dynamo operation in the three-phase windings are rectified and outputted by the AC/DC power converter. The DC voltage applied from outside to the AC/DC power converter is converted into AC voltage and applied to the three-phase windings. A two-phase excitation at a lower rotation range including a starting-up timing during the motor operation is executed by a control of a vector control gate controller. On the other hand, a three-phase excitation is executed during the dynamo operation.

The magnetomotive force of the armature seen from the field magnet poles can be varied by the way how to flow the armature current, depending upon the motor operation or dynamo operation. Concretely, when the electric currents are allowed to flow only X and Y phases among X,Y and Z phases, the norm of the vector sum of the magnetomotive force vectors is 3^{1/2} times as large as that of the magnetomotive force vector of each phase. On the other hand, when the electric currents flows in X, Y and Z phases, the norm of the vector sum of the magnetomotive force vectors is 3/2 times as large as that of the magnetomotive force vector of each phase. Thus, the magnetomotive force in the two phase excitation becomes 3^{1/2}/(3/2)=1.15 times compared with that in the three-phase excitation.

Therefore, even when the three-phase windings are designed to be adaptive to an improved output of the electric power at a higher rotation range, a sufficient starting driving torque can be obtained at the motor operation, by executing two-phase excitation during the motor operation and the three-phase excitation during the dynamo operation. Thus, it becomes possible to improve both the starting-up characteristics during the motor operation and the dynamo characteristics, without greatly increasing the production cost.

The number of slots per phase of the armature corresponding to one of the field magnet poles may preferably be plural, whereby the magnetomotive forces induced in the teeth which are formed between the slots of the armature iron core and are opposite to the rotor are reduced, thereby reducing the inductance per phase of the three-phase windings. Although the conduction angle within which an electric current is allowed to flow during the motor operation is 120°0 which is smaller than 180° for three-phase conduction, the driving currents flow steeply as square waves in the three-phase windings. Accordingly, the effective currents become increased, thereby increasing the magnetomotive force of the armature acting on the field magnet poles and therefore increasing the driving torque during starting. On the other hand, during the dynamo operation, the output current is increased, due to the reduced inductance of the three-phase windings, i.e., due to the decreased internal reactance drop of the three-phase windings. Thus, both the starting torque and generated power are improved by increasing the slot number per phase of the armature.

### BRIEF DESCRIPTION OF THE DRAWINGS

FIG. 1 is a development of a cross sectional structure of the main part of the alternating current dynamotor for vehicle of a preferrred embodiment of the present invention;

FIG. 2 is a circuit diagram of the Ac dynamotor of the preferred embodiment;

FIG. 3 is a timing chart showing the conductive states, during the motor operation of the AC dynamotor, of the transistors which are connected with the three-phase windings and are controlled by a vector control gate controller;

FIG. 4 is a a timing chart showing the conductive states, during the dynamo operation of the AC dynamotor, of the transistors which are connected with the three-phase windings and are controlled by a vector control gate controller;

FIG. 5 is a a timing chart showing the electric currents flowing, during the dynamo operation of the AC dynamotor, in the diodes and transistors which are connected with the three-phase windings and are controlled by a vector control gate controller;

FIG. 6 is a timing chart showing the electric currents flowing in the diodes which are connected with the three-phase windings and are naturally turned on and off; and

FIG. 7 is a graph showing characteristics of an experimentally manufactured AC dynamotor with about 150 amperes capacity.

### PREFERRED EMBODIMENT OF THE INVENTION

A preferred embodiment in accordance with the present invention is disclosed in detail below, referring to the drawings.

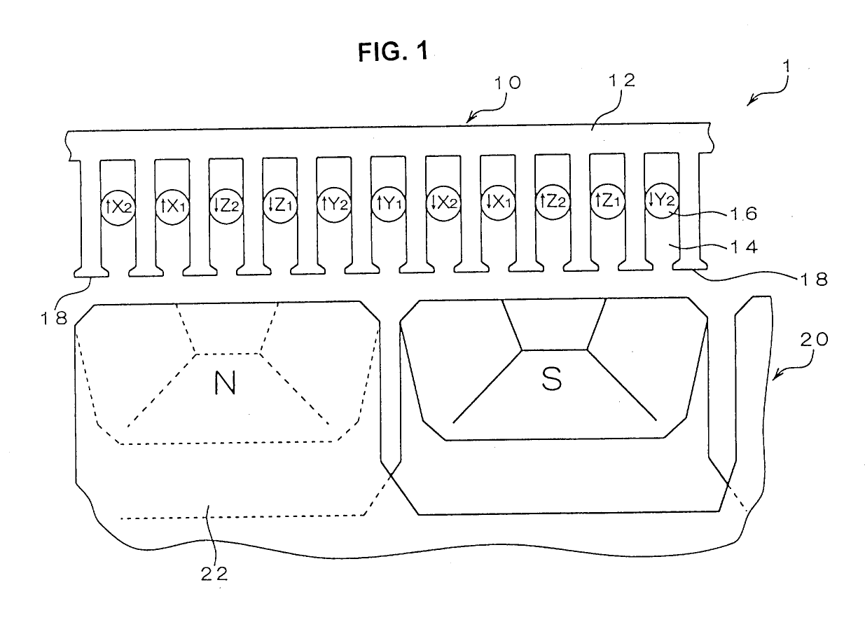

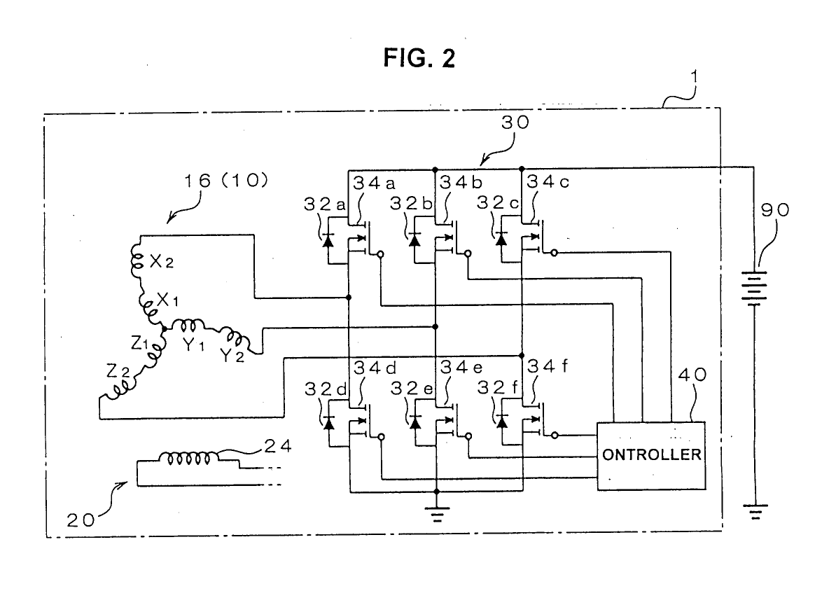

FIG.1 is a cross sectional view of the main part of an AC dynamotor for vehicle in acordance with an embodiment of the present invention. FIG. 2 is a circuit diagram of the AC dynamotor for vehicle.

As shown in FIGS. 1 and 2, The AC dynamotor 1 for vehicle comprises: an armature 10 having three-phase windings 16 as multi-phase windings wound in a plurality of slots 14 provided in an armature iron core 12; and a rotor 20 having a field magnet winding 24 and field magnet poles 22 of the Randel type lump of 16 poles including N and S poles. In a not-shown frame, the armature 10 is supported through a prescribed gap around the outer circumference of the rotor 20 which is allowed to rotate.

The above-mentioned three-phase windings 16 comprises: an X phase winding comprising an X₁ winding and X₂ winding; a Y phase winding comprising a Y₁ winding and Y₂ winding; and a X phase winding comprising a Z₁ winding and Z₂ winding. As shown in FIG. 1, the X₁ and X₂ windings of the X phase winding are received in adjacent two slots. Each winding of the Y and Z phase wingings is received in the similar way. Thus, a number of the slots 14 per phase of the three-phase windings corresponding to one of the field magnet poles 22 is two.

The upward and downward arrows as shown in FIG. 1 show directions of the windings. If an in-phase electric current flows in each winding, the electric current in each winding flows along the direction of the arrow.

Further, the AC dynamotor 1 for vehicle comprises; AC/DC electric power converter 30 which is a combination of 6 diodes 32a˜32f and 6 switching transistors 34a˜34f; and a vector control gate controller 40 for controlling the on/off timings of each of the transistors 34a˜34f. In the AC/DC electric power converter 30 power, for example, MOS transistors are used for the transistors 34a˜34f of which gates are connected with the vector control gate controller. Further, the AC/DC electric power converter 30 is connected with a battery 90 such as a storage battery apparatus with 36 voltages.

When the AC dynamotor for vehicle 1 is operated as a motor at a low speed rotation including the time when the engine is started, the vector control gate controller 40 allows only two of the three-phase windings 16 disposed at a position corresponding to the d-axis of the field magnet poles 22 to flow electric currents, by detecting the position of the rotor 20, or the rotation angle of the field magnet poles 22 in order to switch on or off each of the transistors 34a˜34f.

Here, in the (d,q) conversion model, d-axis is fixed along the N-pole, whereby the three-phase windings resting at the rotor are converted to two “d” and “q” windings rotating synchronously with the rotor and therefore the three-phase windings can be deemed as two independent DC circuits.

The number of slots 14 per phase of the armature 10 corresponding to one of the field magnet poles 22 is fixed to two. Accordingly, the magnetomotive forces induced in the teeth 18 which are formed between the slots 14 of the armature iron core 12 and are opposite to the rotor 20 are reduced, thereby reducing the inductance per phase of the three-phase windings 16. Although the conduction angle within which the electric current is allowed to flow during the motor operation is 120° which is smaller than 180° for three-phase conduction, the driving currents flow steeply as square waves in the three-phase windings 16. Accordingly, the effective currents become increased, thereby increasing the magnetomotive force of the armature 10 acting on the field magnet poles 22 and therefore increasing the driving torque during starting.

When the AC dynamotor for vehicle 1 is operated as a dynamo, the vector control gate controller 40 switches on or off each of the transistors 34a˜34f by detecting the position of the rotor 20 in order to flow electric currents in all of the three-phase windings 16. The position of the rotor 20 may be detected, for example, by outputs from Hall devices disposed in the vicinity of the inner circumference of the armature iron core 12, or by other methods.

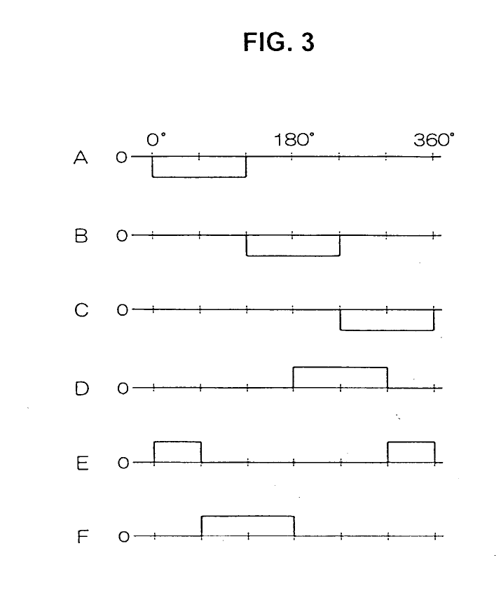

FIG. 3 shows the conductive state of the transistors 34a˜34f during the motor operation, where A˜F are the gate voltages of the transistors 34a˜34f, respectively, applied by the vector control gate controller 40. Only two among the six transistors 34a˜34f are allowed to be switched on at any timing by the vector control gate controller 40, thereby switching on the two-phase currents by selecting the two windings among the three-phase windings 16.

The number of slots 14 per phase of the armature 10 corresponding to 1 pole of the field magnet poles 22 is fixed to 2. Accordingly, the magnetomotive forces induced in the teeth 18 which are formed between the slots 14 of the armature iron core 12 and are opposite to the rotor 20 are reduced, thereby reducing the inductance per phase of the three-phase windings 16. Although the conduction angle during the motor operation is 120° which is smaller than 120° for three-phase conduction, the driving currents flow steeply as square waves in the three-phase windings 16. Accordingly, the effective currents become increased, thereby increasing the magnetomotive force of the armature 10 acting on the field magnet poles 22 and therefore increasing the driving torque during starting.

When the AC dynamotor for vehicle 1 is operated as a dynamo, the vector control gate controller 40 switches on or off each of the transistors 34a˜34f by detecting the position of the rotor 20 in order to flow electric currents in all of the three-phase windings 16. The position of the rotor 20 may be detected, for example, by outputs from Hall devices disposed in the vicinity of the inner circumference of the armature iron core 12, or by other methods.

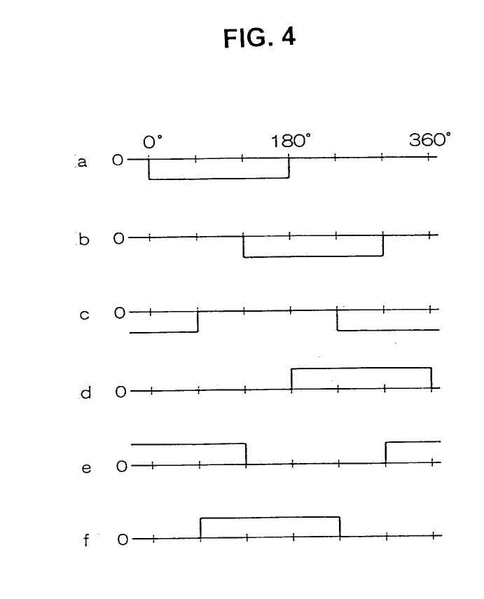

FIG. 4 shows conceptual conductive states a˜f of the transistors 34a˜34f during the dynamo operation, respectively. As shown in FIG. 4, three among the six transistors 34a˜34f are allowed to become conductive at any timing, thereby switching on the three-phase currents in the three-phase windings 16.

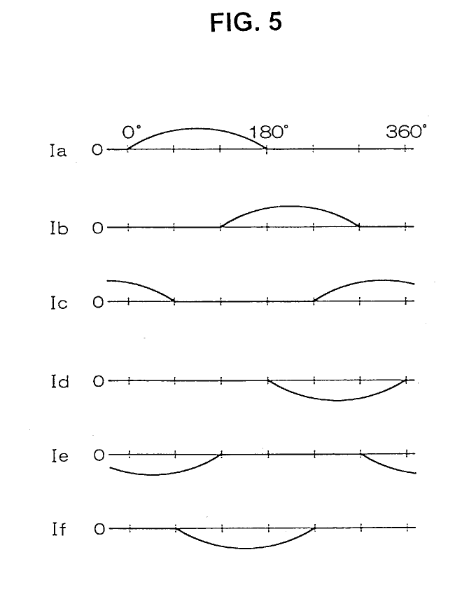

FIG. 5 shows the electric currents Ia˜If flowing through the transistors 34a˜34f, respectively, during the dynamo operation. Here, the electric currents flowing through diodes 32a˜32f connected in parallel with the transistors 34a˜34f, respectively are included in the electric currents Ia˜If.

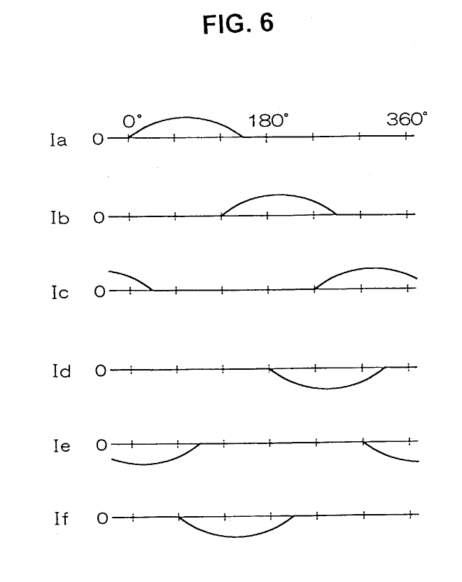

The electric current in a conventional rectifying apparatus comprising exclusively diodes does not flow in the whole range of 180° as shown in FIG. 5, but flow within a range narrower than 180° as an electric current naturally turned on and off in a diode as shown in FIG. 6. On the contrary, the electric current can be surely outputted in the whole 180° range from the AC dynamotor 1 by using the transistors 34a˜34f of which conductive states are controlled as shown in FIG. 4.

The rotor 20 is connected by a belt with a not-shown engine under a pulley ratio, e.g., 3. Therefore, when the AC dynamotor for vehicle 1 is operated as a dynamo, the rotor 20 is driven to rotate at a number of rotations per unit time three times as high as that of the engine, and the engine is driven, by the dynamoror operating as a motor, to rotate at a one third of the number of rotations of the rotor 20.

In the three-phase windings 16 provided in the armature 10, there are arranged 4 conductive wires per phase per slot and 128 conductive wires in series per phase around the whole poles around the whole round. Further, the starting-up number of rotations during the dynamo operation is fixed to, e.g., about 1300 rpm over which the induced electromotive force, i.e., the output voltage of the AC/DC power converter 30 may be designed to become greater than the battery voltage.

As explained above, the AC dynamotor for vehicle of the present embodiment varies the magnetomotive force of the armature 10 seen from the field magnet poles 22, by varying the armature current, depending upon the motor operation or dynamo operation. Concretely, the norm of the vector sum of the magnetomotive force vectors during the two-phase excitation is 3^{1/2} times as large as that of the magnetomotive force vector of each phase, while the norm of the vector sum of the magnetomotive force vectors during the three-phase excitation is 3/2 times as large as that of the magnetomotive force vector of each phase. Thus, the magnetomotive force becomes 3^{1/2}/(3/2)=1.15 times as large as that in the three-phase excitation. Therefore, even when the three-phase windings 16 are designed to be adaptive to an improved output of the electric power at a higher rotation range, a sufficient starting driving torque can be obtained at the motor operation, by executing two-phase excitation during the motor operation and the three-phase excitation during the dynamo operation. Thus, it becomes possible to improve, without greatly increasing the production cost, both the starting-up characteristics during the motor operation and the dynamo characteristics.

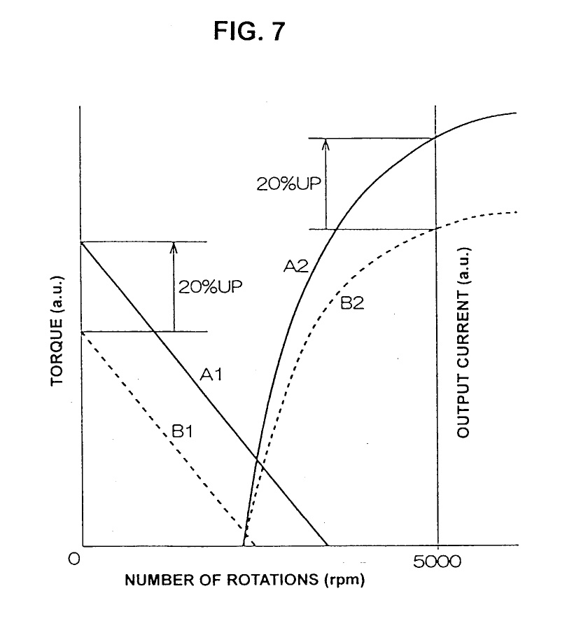

FIG. 7 shows the performances of experimentally manufactured AC dynamotor with about 150 amperes capacity. The torque A1 of the experimental manufacture was improved about 20%, compared with B1 of the conventional three-phase excitation. Further, the output current A2 during the dynamo operation of the experimental manufacture was improved 20% at 5000 rpm, compared with B2 of the conventional rectifying apparatus comprising exclusively diodes.

The present invention is not limited to the above-explained embodiment, but modifications thereof can be made within the scope thereof. For example, although the number of slots 14 per phase of the armature 10 corresponding one pole of the field magnet poles 22 was foxed to two, the slot number may be one for two-phase and three-phase excitation, thereby obtaining the effect similar to that of the above-described preferred embodiment. Further, the slot number may be greater than three, thereby reducing the inductance per phase of the three-phase windings 16.

Further, although the two-phase excitation was executed at the starting-up timing of the motor operation, the torque may be increased by such a method that three-phase excitation is executed at a rotation range higher than that during the starting-up in order to raise a fundamental wave component of applied voltage, thereby equivalently an internal voltage.

Further, although the gates of the transistors 34a˜34f are switched on in the range of 180° during the dynamo operation, the driving method for the transistors may be simplified in such a manner that all of the transistors 34a˜34f are switched off and the dynamo current is outputted through the diodes 32a˜32f which naturally turn on and off. As already mentioned, the power generation efficiency is lowered, because the conductive range becomes smaller than 180° due to the natural turning on and off of the diodes. However, the starting torque is advantageously increased. Furthermore, the number of turns of the three-phase windings 16 may be decreased in proportion to the increase in the torque, thereby increasing the output current during the dynamo operation in order to consistently improve both the torque durint the motor operation and output current during the dynamo operation.

Further, although three-phase windings 16 were employed, multiple-phase windings may be employed. Furthermore, the number of field magnet poles 22 of the rotor 20 may not necessarily 16.

What is claimed is:

1. A dynamotor for vehicle comprising:
a rotor having field magnet poles;
an armature having three-phase windings in slots provided in a core of said armature opposite to said rotor;
an AC/DC electric power converter connected with said armature, for outputting during a dynamo operation a DC voltage converted from an AC voltage induced in said three-phase windings and for outputting during a motor operation an AC voltage converted from a DC voltage; and
a battery for supplying an electric power for said motor operation and storing an electric power generated by said dynamo operation,
wherein:
electric currents are allowed to flow in two among said three-phase windings during said motor operation; and
electric current are allowed to flow in all of said three-phase windings during said dynamo operation.

2. The dynamotor according to claim 1, wherein a number of said slots per phase per field magnet pole is a plural number.

3. The dynamotor according to claim 1, wherein said AC/DC electric power converter includes;
a plurality of rectifying elements connected phase by phase with said windings;
a plurality of switching elements connected with said rectifying elements in parallel, respectively; and
a vector control gate controller for switching on and off said switching elements.

4. The dynamotor according to claim 2, wherein said vector control gate controller switches on during said motor operation two switching elements connected with different phases wherein a switching-on period of said switching elements is made smaller than 180°.
